(19) United States
(12) Patent Application Publication
(10) Pub. No.: US 2026/0139515 A1
(43) Pub. Date: May 21, 2026

(54) BRACKET AND LOCKING MECHANISM THEREFOR

(71) Applicant: Conopco, Inc., d/b/a UNILEVER, Englewood Cliffs, NJ (US)

(72) Inventors: Anoop CHERIAN, Pune (IN); Nurani Dharmaraj Krishnaprakash IYER, Kandivili West (IN); Arun Babulal RATHOD, Mumbai (IN)

(73) Assignee: Conopco, Inc., d/b/a UNILEVER, Englewood Cliffs, NJ (US)

(21) Appl. No.: 18/950,684

(22) Filed: Nov. 18, 2024

(51) Int. Cl. E05B 47/00; A47K 5/02

(52) U.S. Cl. CPC E05B 47/004; E05B 47/0045; A47K 5/02; A47K 2201/00

(57) ABSTRACT

A magnetic locking mechanism which includes a locking pin having a ferromagnetic upper surface or aspect, a locking receptacle having a shaft suitable for receiving the pin, the shaft intersecting with a transverse opening whereby a portion of the pin will be received within a portion of the transverse opening, and a key comprising an upper grasping portion and a lower portion made of ferromagnetic material which is attracted to the locking pin ferromagnetic upper surface. The magnetic locking mechanism may be used in combination with a wall mountable bracket. The bracket may include a rear plate, upper front and rear flanges for retaining one or more bottles’ and one or more pairs of base flanges. Each flange in a pair of base flanges is spaced laterally from the other except for the presence of a bridge between them. On the bridge is a protuberance which is preferably at least partly received within a well of a bottle to limit movement of the bottle bottom.

### BACKGROUND OF THE INVENTION

Hotels and motels typically provide personal cleaning products, like face, hand and body cleansing products to consumers in their rooms. Often, these have been in the form of small plastic bottles. One problem with those products is that manufacture of a large number of small bottles is likely to use more plastic and take up more landfill space than larger bottles provided in fewer numbers or which are re-used. In addition, consumers often take unused product home in the small bottles, so more cleaning product is needed.

Haworth US Patent No. 9,155,428 discloses a toiletries dispensing device configured to support dispensing of toiletries from a dispensing bottle. It includes a back plate which supports a means for mounting the device on a wall. The device may include a plurality of dispensing bottles and removable and stationary sections. A mountable lock for locking the dispensing bottles in place, and a bottom support with a smooth surfacing that the dispensing bottles are set on, are also provided.

Schmidt US Patent Application No. 2023/0121064 is directed to a wall mounted dispenser including a replaceable container and a wall bracket. The wall bracket includes first and second mutually spaced apart fixing locations for the container.

Pacini WO 22/237985 (La Bottega Dell’Albergo SPA) is directed to a detergent or disinfectant dispenser unit including a shelf suitable for supporting at least one bottle. It includes a first half body comprising a base plate which frontally projects from a front wall to penetrate a second half body. When replacing an empty bottle, a key is inserted to make flexible claws retract releasing the second half body from the claws which no longer hinder sliding movement of the second half body so as to release the bottle from the grip of a serrated edge.

Runius WO 2021/177878 (Runius Design AB) discloses a lockable receptacle holder comprising a holder base portion, a holder upper portion and an elongated holder back portion extending between the holder base portion and the holder upper portion. The holder upper portion comprises an at least partially closed space (C) configured to at least partially enclose and releasably confine the neck or shoulder of a receptacle placed on the holder base portion.

Runius WO 2021/076034 (Runius Design AB) discloses a receptacle holder including a holder base portion, a holder upper portion and an elongated holder back portion. The holder includes a confining member having a hook shaped front portion and pivotally attached to the holder upper portion so that the confining member may pivot relative to the holder upper portion between a closed position and a release position. The holder includes a locking member attached to one of the holder upper portion and the confining member and having a locking portion configured to be received into one opening of a through hole in the other of the holder upper portion and the confining member when the confining member is in the closed position thereby preventing movement of the confining member.

Carson US Patent No. 9,146,003 discloses a quick change sample cylinder clamping bracket. The bracket includes front and rear jaw elements having pivotal hinges. In one embodiment, a battalion latch with an adjustable length hook is mounted to the first jaw and the battalion latch is capable of engaging a plate member of the second jaw.

Li et al. US Patent No. 11,357,365 discloses a soap dispenser for use in a shower room in a hotel bathroom. The dispenser includes bottles and a placement sheet one side of which is bent down in an arc shape. Placement rings are provided on the placement sheet. A fixing sheet is hinged to the placement sheet.

Just et al. US Patent No. 9,988,211 (Stericycle Inc.) is directed to a mounting bracket for mounting a container to a support surface. The mounting bracket includes a base configured to be mounted to a support surface, a securing member pivotally coupled to the support portion for movement in only a single pivot plane, a lock operable to selectively lock the securing member in a second position in which the container cannot be removed from the support portion, a portion of the lock being movable in a direction orthogonal to the single pivot plane and wherein at least one of the base or the securing member includes an aperture through which a portion of another one of the base or the securing member extends when the securing member is in the second position. The ‘211 device may also have a lock wherein rotation of a key moves the lock between a locked state and an unlocked state or a lock having a pawl which extends through a notch in the securing member and a slot in the support portion.

Limbert et al. US Patent No. 9,920,553 concerns a point of care dispenser which includes a hand hygiene cartridge chamber. A dispenser cover is secured to the main body, and at least one dispenser cover interlock undercut feature engages a main body interlock undercut feature when the dispenser cover is in the closed position and wherein engagement between the underlock features increases in response to an increase in a prying force used to move the dispenser cover from the closed condition to the open condition.

Rosenkranz et al. US Patent No. 8,561,847 discloses a dispenser housing which includes a base and a cover movable between an open position and a closed position relative to the base. The dispenser includes a closure mechanism and a release mechanism. The release mechanism has a rest position and a key induced position. In the rest position, the release mechanism cannot be manipulated to override the closure mechanism whereas in the key induced position the release mechanism can be manipulated to override the closure mechanism.

There is still a need for a dependable wall-mountable, lockable bracket, particularly for securing large bottles of personal product in hotel rooms and the like. There is also a need for a more convenient locking mechanism and for a bracket incorporating such locking mechanism.

### SUMMARY OF THE INVENTION

The invention is directed to a wall mountable bracket, especially suitable for containing one or multiple bottles of personal care items such as body wash or other personal washing or skin or hair care products. In one embodiment, the bracket includes a back plate suitable for mounting to a wall, a rear flange with an optional opening for containing a portion of a bottle and a front flange also containing an optional opening for a portion of a bottle. The rear and front flanges are optionally pivotally-connected at one of their ends. A lock is associated with the front and rear flanges, and when the front and rear flanges are brought together and locked the upper ends, preferably necks, of one or two or more bottles are retained between the flanges. Where one or more openings are present on the flanges the upper ends of the bottles may be accommodated within the openings. In one embodiment, a solely mechanical lock is used. In another embodiment, the lock is magnetized in that it includes a magnetic component. The invention is also directed to the magnetized lock, itself.

The bracket includes a base extending from a lower end of the back plate which may serve to support a portion of a base of the bottle(s) or at least prevent their movement too far downwardly. In an especially preferred embodiment the base comprises multiple spaced flanges, one or more pairs of which are connected by a bridge having a protuberance extending upwardly to support a portion of a bottom of a bottle and/or to be received within a well at the bottom of the bottle.

The locking mechanism may include a locking pin having a ferromagnetic upper surface or other upper portion, a locking receptacle having a shaft suitable for receiving the pin, the shaft intersecting with a transverse opening whereby a portion of the pin will be received within a portion of the transverse opening and a key comprising an upper grasping portion and a lower portion made of ferromagnetic material. The ferromagnetic upper locking pin surface (or other upper portion) and the ferromagnetic material of the key are attracted to each other so that placing the key at the top of the shaft results in the pin moving upwardly to the key.

The invention also includes a process of using the locking mechanism by dropping the pin in the shaft whereby the pin locks a flange or other object received within the transverse opening. The locking mechanism is opened by applying the ferromagnetic material of the key to an upper end of the shaft, whereby to attract the ferromagnetic upper surface or aspect of the locking pin and lift the pin away from the flange or other object, thereby unlocking it. The magnet is left in contact with the locking pin until it is again desired to lock the locking mechanism.

The wall mountable bracket of the invention may comprise one or more of the following:

a back plate suitable for mounting to a wall outwardly of said plate;

one or more base flanges extending from the back plate generally perpendicularly inwardly at a lower end thereof;

one or more rear flanges extending from the back plate, extending generally perpendicular to the back plate inwardly at an upper end thereof;

the one or more rear flanges including one or two or more openings suitable for receiving a portion of an upper end of one, two or more bottles;

one or more front locking flanges comprising one or two or more openings suitable for receiving a portion of an upper end of one, two or more bottles;

the rear flange and front locking flange together suitable for securing a portion of an upper end of one or two or more bottles;

the rear flange and the one or more front locking flange being pivotally connected at one of their ends;

a lock releasably securing the one or more rear flanges and/or back plate to the one or more front locking flanges;

wall mountable bracket wherein the one or more front locking flanges comprise at least two horizontal flanges generally perpendicular to the back plate and a connecting flange generally parallel to the back plate;

wall mountable bracket wherein the one or more rear flanges comprise at least one horizontal flange extending from and generally perpendicular to the back plate;

wall mountable bracket wherein the openings suitable for receiving a portion of one or two or more bottles are present on each of the rear flanges and front locking flanges;

wall mountable bracket wherein one or more base flanges comprise at least two flanges connected by a bridge;

wall mountable bracket wherein at least one bridge comprises a protuberance extending above the bridge; wall mountable bracket wherein the at least one protuberance is circular in horizontal cross section;

wall mountable bracket wherein the at least one protuberance comprises a dome button; wall mountable bracket wherein the at least one bridge includes a bridge opening for securing a protuberance;

wall mountable bracket comprising at least one protuberance secured to the bridge with a screw extending through the bridge opening and the protuberance(s);

wall mountable bracket wherein the base flanges connected by a bridge are spaced from each other except for the bridge;

wall mountable bracket wherein the rear flange and the front locking flange secure a neck of at least one bottle;

wall mounted bracket wherein the at least one protuberance is at least partly accommodated within a well of the bottom of the bottle when the bottle sits on or above the base flange;

wall mountable bracket wherein the at least one protuberance is suitable to assist in retaining a portion of a bottom of a bottle on or above the base flange;

wall mountable bracket wherein the at least one protuberance is suitable to assist in retaining a portion of a bottom of a bottle on the base flange by preventing or limiting movement of the bottle bottom on or above the base flange;

the wall mountable bracket made of metal;

the wall mountable bracket made of stainless steel; a locking mechanism comprising a magnet, a locking pin and a pin receptacle;

wall mountable bracket wherein the one or more front locking flanges and the one or more rear flanges include an opening at one of their ends to accommodate a pin on which the one or more front locking flanges rotates to open and close the bracket;

a locking mechanism comprising a locking pin having a ferromagnetic upper surface or other upper aspect, a locking receptacle having a shaft suitable for receiving the pin, the shaft intersecting with a transverse opening whereby a portion of the pin will be received within a portion of the transverse opening when the pin is dropped into the shaft;

a key comprising an upper grasping portion and a lower portion made of ferromagnetic material such that the ferromagnetic material of the key and the ferromagnetic upper surface/aspect of the pin are attracted to each other;

a locking mechanism wherein the ferromagnetic locking pin upper surface or aspect is comprised of one or more of iron, steel, nickel and cobalt;

a locking mechanism wherein the ferromagnetic material of the key is comprised of one or more of iron, steel, nickel and cobalt;

a locking mechanism wherein the pin includes upper and lower generally cylindrical sections, the upper cylindrical section having a larger diameter;

a locking mechanism wherein the locking receptacle is in the form of a block; a locking mechanism wherein the transverse opening is a slot;

a locking mechanism wherein the grasping surface of the key includes a handle;

a process of using a locking mechanism to lock a wall mounted bracket comprising a back plate and/or rear flange and a front locking flange wherein the back plate and/or rear flange and the front locking flange have an open position with the front locking flange distal from the back plate and/or rear flange and a closed position with the front locking flange proximal to the back plate and/or rear flange and wherein a locking receptacle is secured to one of the front flange and the back plate or flange, the process comprising with the front flange and back plate and/or rear flange in the closed position, dropping the locking pin so that it extends at least partly through one of a front locking flange or a rear flange whereby a front locking flange and back plate are locked;

a process of opening a locking mechanism in a locked wall mounted bracket comprising a back plate and/or rear flange and a front locking flange wherein the back plate and the front locking flange have an open position with the front locking flange distal from the back plate and a closed position with the front locking flange proximal to the back plate and wherein the locking receptacle is secured to one of the front flange and the back plate or rear flange, with the front flange and rear plate in the closed position and wherein the locking pin is dropped so that it extends at least partly through one of a front locking flange or a rear locking flange whereby the front locking flange and back plate are locked, comprising apply the key to the upper end of the shaft in the locking receptacle to attract the locking pin to a position in an upper end of the shaft whereby at least part of the transverse opening is free of the pin and the front locking flange and the back plate are free to move with respect to each other;

wall mountable bracket including a back plate suitable for mounting to a wall outwardly of the plate, at least one closing flange movable from a position proximal to the back plate to a position distal to the back plate, the locking receptacle being mounted on one of the back plate or the closing flange, the back plate optionally also including a flange such optional back plate flange extending inwardly from the back plate, the back plate flange or the closing flange being at least partly received within the transverse opening when the locking flange is proximal to the back plate whereby upon dropping the pin can lock the bracket;

bracket wherein one or more of the front locking flange and a rear flange includes a pin-receiving opening into which the pin drops to lock the bracket;

the back plate flange and the front locking flange being suitable for securing between them a portion of an upper end of a bottle; wall mountable bracket wherein one or more base flanges comprise at least one pair of flanges connected by a bridge;

a process of using a locking mechanism to lock together a first and second object wherein the first object is attached to a locking receptacle having a shaft, comprising dropping a locking pin having a ferromagnetic surface or aspect at an upper end through the shaft on the locking receptacle so that at least a portion of the locking pin extends at least partly through a transverse opening in the locking receptacle and at least partly through the second object which extends into the transverse opening whereby the first and second objects are locked together;

a process of using a locking mechanism to open a first and second object which are locked together wherein the first object is attached to a locking receptacle having a shaft and wherein the locking mechanism was locked by dropping a locking pin having a ferromagnetic material at an upper end through the shaft in the locking receptacle so that at least a portion of the locking pin extends at least partly through a transverse opening in the locking receptacle and at least partly through at least a portion of the second object which extends into the transverse opening whereby the first and second objects were locked together, the process comprising applying a key having a ferromagnetic surface to an upper end of the shaft so that the key and the ferromagnetic surface or other upper ferromagnetic aspect of the locking pin are attracted to each other and the pin raises in the shaft until it is at least partially removed from the transverse opening and is removed from the second object whereby the first and second objects are free to move relative to each other;

a process of using a locking mechanism to lock a wall mounted bracket.

For a more complete understanding of the above and other features and advantages of the invention, reference should be made to the following detailed description of preferred embodiments and to the accompanying drawings.

### BRIEF DESCRIPTION OF THE DRAWINGS

FIG. 1 is a perspective view of a two bottle bracket according to the invention with the front flange and back panel closed and proximal to each other.

FIG. 2 is a front elevational view thereof;

FIG. 3 is a rear elevational view thereof;

FIG. 4 is a side elevational view from the left;

FIG. 5 is a side elevational view from the right;

FIG. 6 is a top plan view thereof;

FIG. 7 is a bottom plan view thereof.

FIG. 8 is a perspective view thereof with the locking flange in the open position with the front flange and back panel distal to each other.

FIG. 9 is an exploded perspective view of a one bottle bracket of the invention with an alternative lock.

FIG. 10 is a front elevational view of the one bottle bracket of FIG. 9 with the position of the locking mechanism in the locking position at a lower end of the shaft of the locking receptacle shown in phantom.

FIG. 11 is an elevational view of a bottle which may be contained within the brackets of the invention.

FIG. 12 is a bottom perspective view of the bottle of FIG. 11.

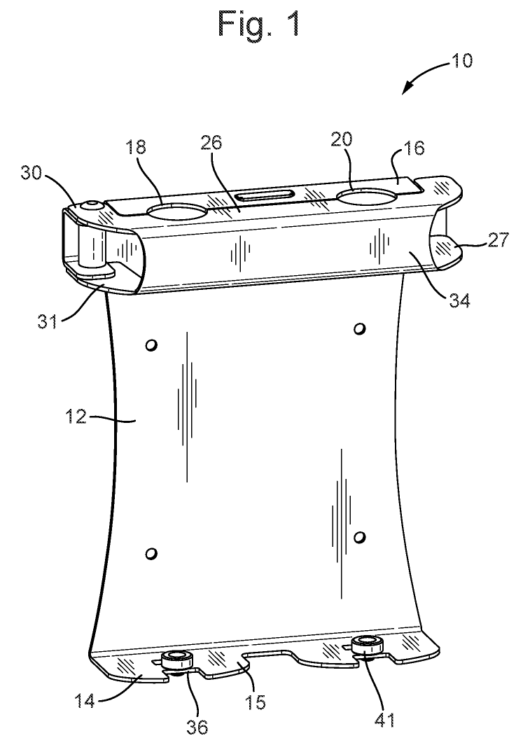

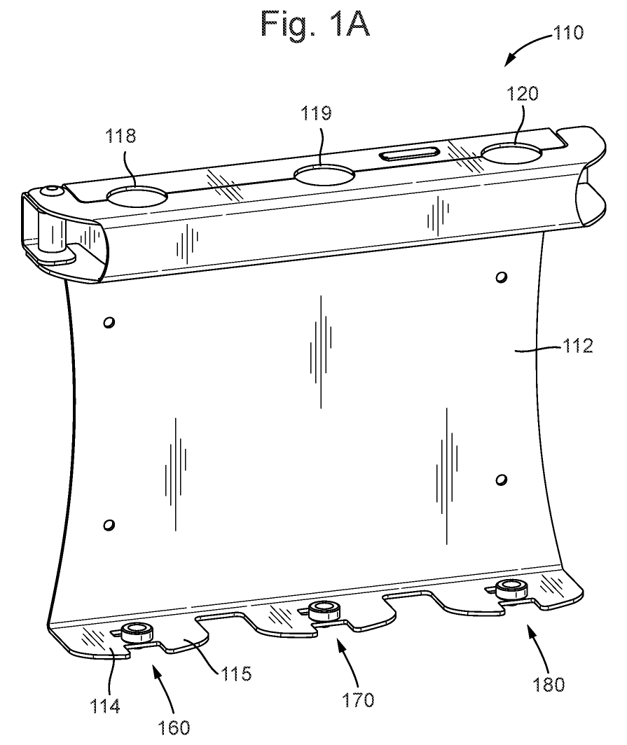

FIG. 1a is a perspective view of a three bottle bracket according to the invention with the front flange and back panel closed and proximal to each other.

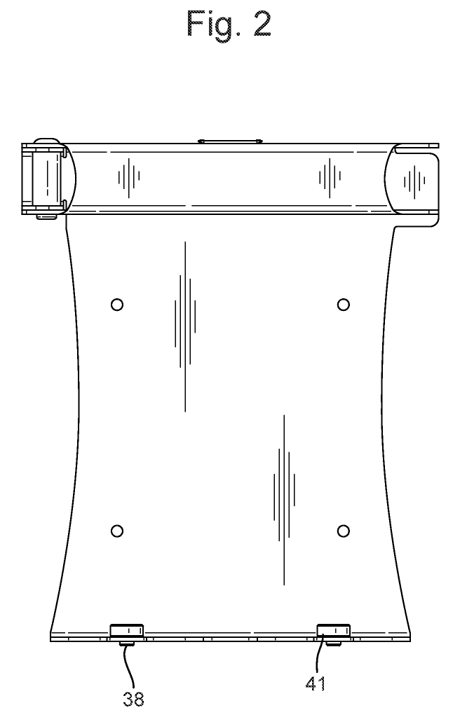

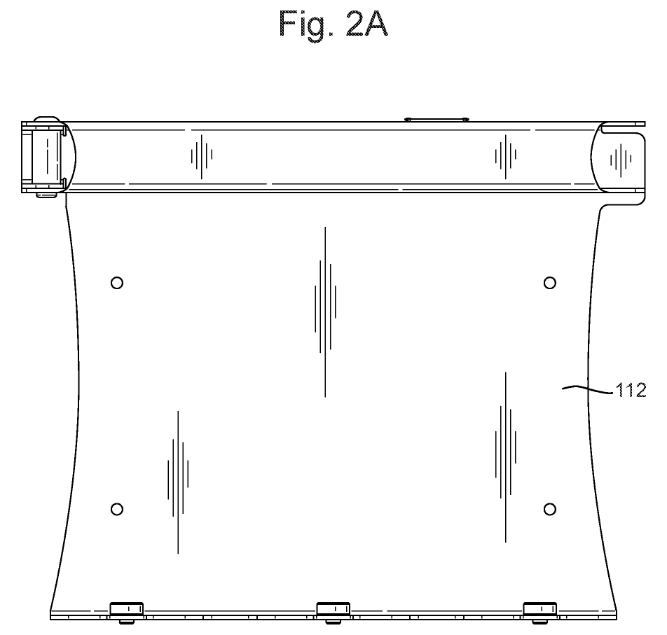

FIG. 2a is a front elevational view thereof;

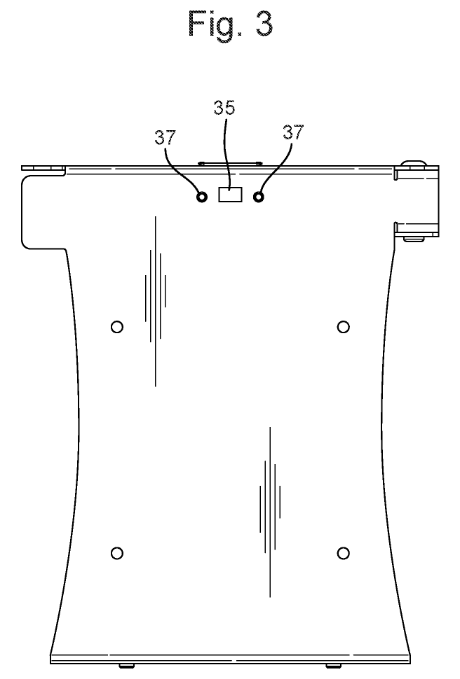

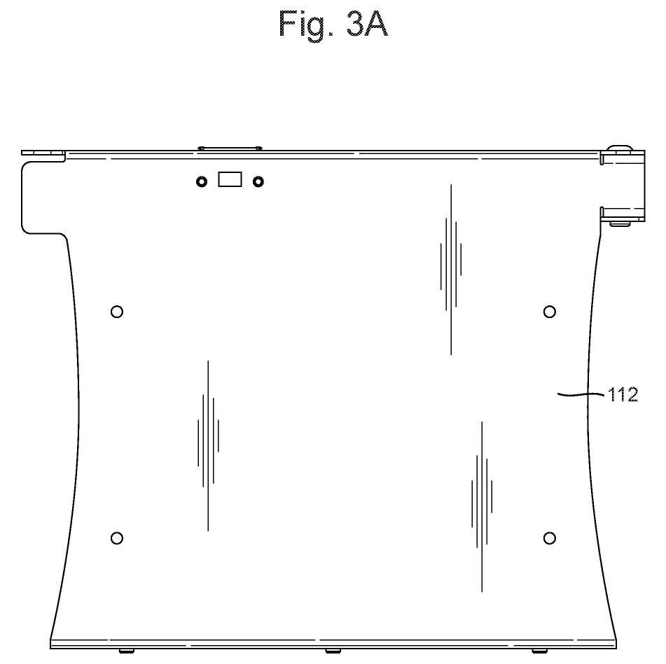

FIG. 3a is a rear elevational view thereof;

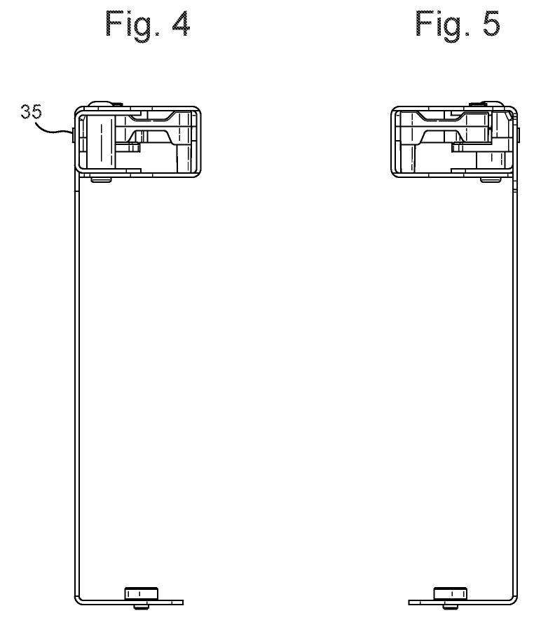

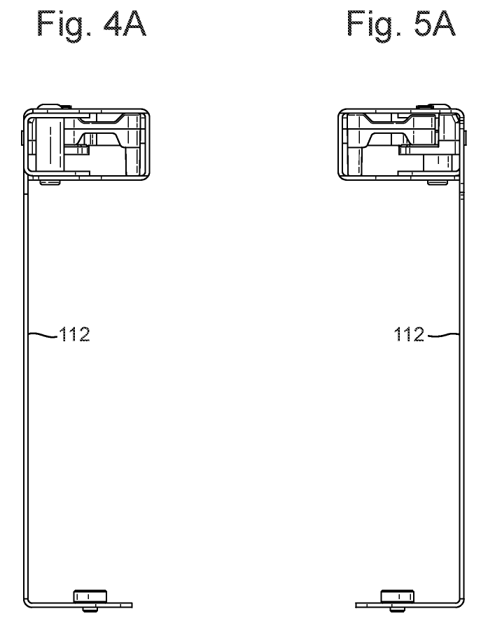

FIG. 4a is a side elevational view from the left;

FIG. 5a is a side elevational view from the right;

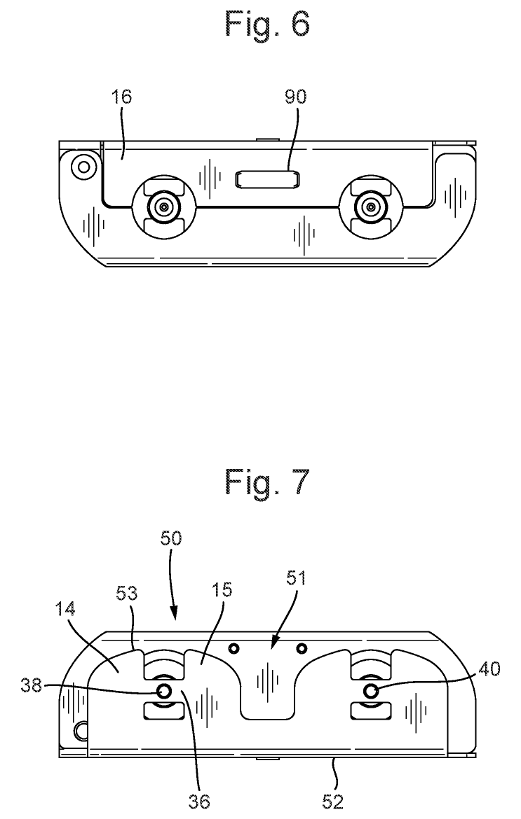

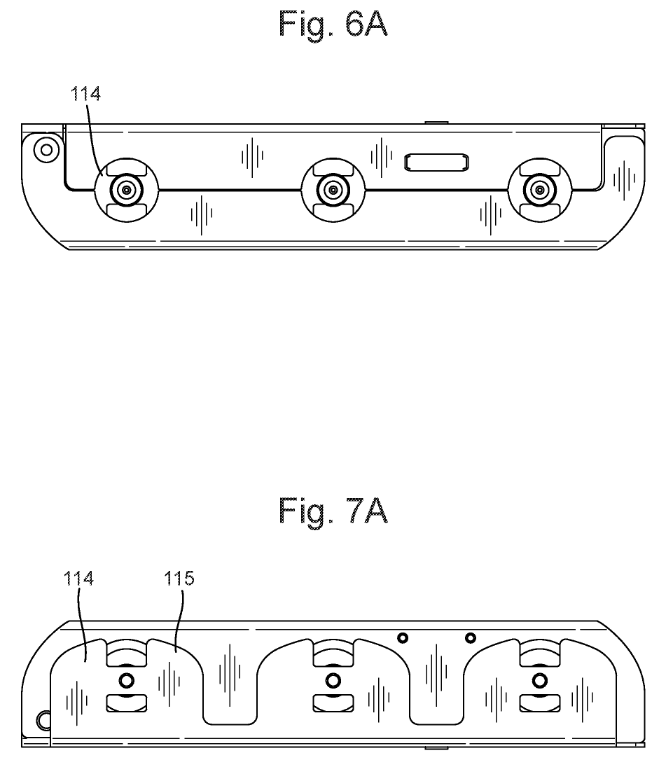

FIG. 6a is a top plan view thereof;

FIG. 7a is a bottom plan view thereof.

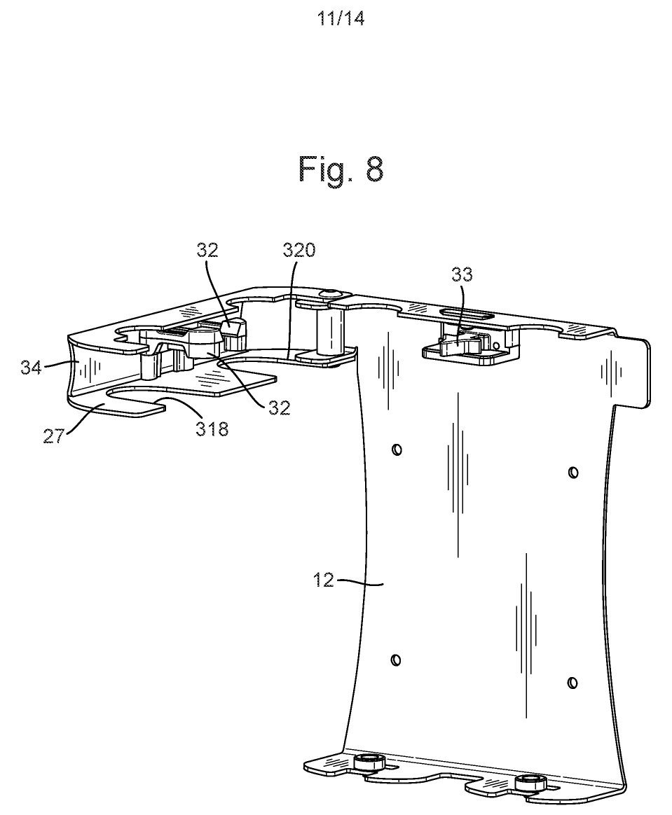

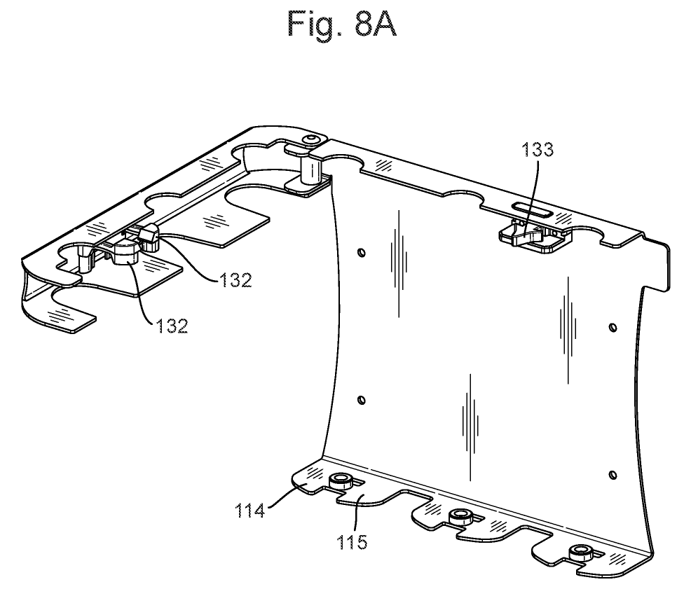

FIG. 8a is a perspective view thereof with the locking flange in the open position with the front flange and back panel distal to each other...

### DETAILED DESCRIPTION OF THE INVENTION

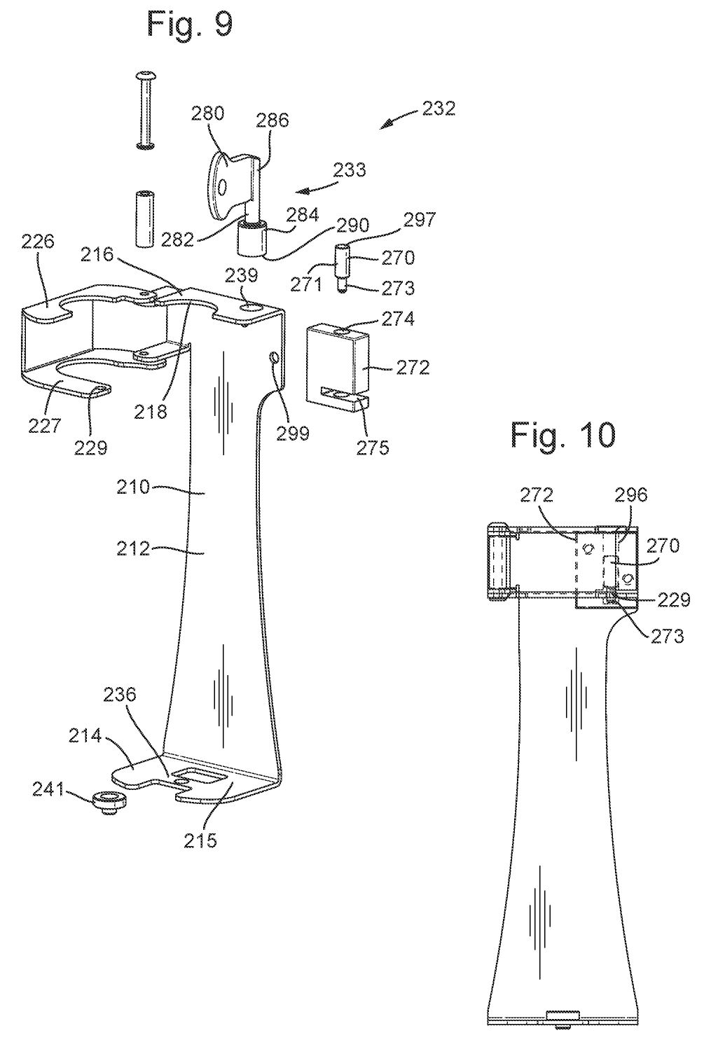

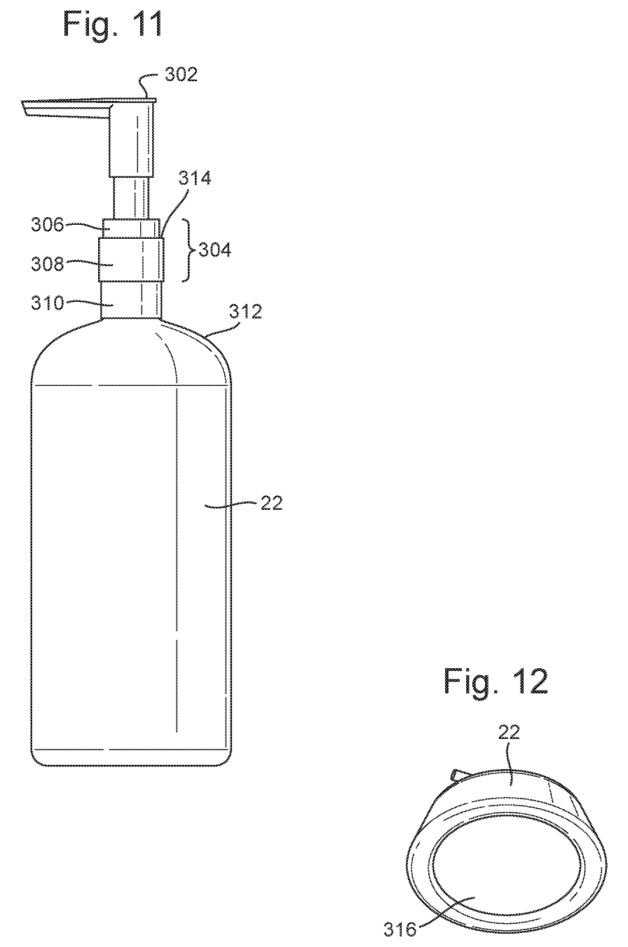

Bracket 10 comprises back plate 12, which is suitable for mounting to a wall outwardly of the plate (along the reverse side of the plate than that shown in FIG. 1). The back plate is planar or flat. One or more base flanges 14, 15 extend generally perpendicularly to the back plate inwardly (in the direction shown in FIG. 1) at a lower end thereof. A rear flange 16, extends generally perpendicular to the back plate inwardly at an upper end thereof. The rear flange includes openings 18, 20 suitable for receiving a portion of an upper end of two or more bottles 22 (FIG. 11). Bracket 10 is shown with openings for two bottles but it may have more, or fewer. For instance, bracket 110 (FIG. 1a) has three openings and bracket 210 (FIG. 9) has one.

As seen in FIG. 11, bottle 22 includes pump head 302, closure 304, and neck 310 above shoulder 312. Closure 304 includes two integral cylindrical parts, a first part 306 and a second part 308 with a larger diameter, separated by a circular platform 314.

Bracket 10 further includes one or more front locking flanges 26, 27 optionally comprising openings suitable for receiving a portion of two or more bottles 22 such as the other halves of openings 18 and 20 as seen in FIG. 1. The rear flange 16 and front locking flange 26, optionally together with second front locking flange 27, are suitable for together securing a portion of an upper end of a bottle. Optional openings forsecond locking flange 27 for accommodating the bottles can be seen as openings 318 and 320 in FIG. 8. Openings 18, 20 may encircle the bottle at the level of the smaller diameter cylindrical portion 306 of closure 304 (FIG. 11). If present, openings 318, 320 of second front flange 27, together with back plate 12 surround bottle 22 at the level of neck 310. The rear flange 16 and the one or more front locking flanges 26, 27 are pivotally connected at one of their ends 30, 31.

A mechanical locking system or simply lock 32, 33 (FIG. 8) directly or indirectly connected to one or both of the rear flange or back panel and the front locking flange releasably secures the rear flange to the one or more front locking flanges. In the embodiment of FIGS. 1-8, lock component 32 is disposed between and touching front locking flanges 26 and 27 and rests against front connecting flange 34, discussed below. Lock component 33 rests against and is attached to back plate 12, the lock including a protuberance 35 (FIG. 3) which extend through an opening in back plate 12 to assist in keeping lock 33 in place. Screws 37 (FIG. 3) may also assist in keeping lock component 33 in place. One or more keyholes 90 (FIG. 6) may be provided in one or both of the front and rear flanges, especially in the rear flange or the uppermost front flange.

Although illustrated as generally rectangular, the keyhole may take other forms, e.g., two spaced but adjacent rectangular or square openings to match two prongs on a key used to release the front flange(s) from the rear flange and thereby provide access to any bottles in the bracket.

Preferably, the one or more front locking flanges comprise at least two horizontal flanges 26, 27 generally perpendicular to the back plate and connecting flange 34 joining flanges 26 and 27 and generally parallel to the back plate.

The one or more base flanges preferably comprise at least one pair of flanges 14, 15 connected by a bridge 36. More preferably, at least one such bridge comprises a protuberance 41 extending above the bridge. The protuberance 41 may be circular in horizontal cross section, as shown. For instance, protuberance 41 is a dome button secured to the bridge 36 with a stud 38 (FIG. 2) which extends through an opening 40 in the bridge. The protuberance may also be secured to the bridge with a screw or pin extending through the bridge opening and the protuberance. As illustrated, the base flanges of the at least one flange pair are spaced from each other except for the bridge and their attachment to back plate 12.

The bracket of the invention is best used in conjunction with one or more bottles which include wells at the bottom so that the interiors of the bottoms are not flat but are raised relative to their peripheries. The protuberance is suitable to be at least partly received within the well. In operation, with the front flanges in the open position away from the rear flange as seen in FIGS. 8 (and 8a), one or more bottles are placed on one or more pairs of base flanges 14, 15. Button 41 is at least partly received within the well(s) 316 of the bottle(s) (FIG. 12) to help retain the bottle(s) in place. An upper end of the one or more bottles is usually received within one or more of the openings 18, 20 in either the upper front flange or the rear flange, or both.

With the bottle or bottles in place, front flange(s) are swung into the closed position and locked into the rear flange and/or rear plate. Mechanical lock component 33 includes a barb-like projection which is releasably received within mirror image clamping members 32 upon locking (FIG. 8). The clamping members, which may be made of plastic, are biased toward each other and when the front flange is closed, the barb like projection is forced between them and grasped by the clamping members to lock the bracket.

When locked, the front and rear flanges retain the upper portions of the bottles within the bracket while the presence of the protuberance at least partly residing in the well of the bottle prevents or limits movement of the bottom of the bottle and serves to help keep it on or above the base flanges. Release and opening occurs as a result of insertion of a key (not shown) into key hole 90. The key may have, e.g., two prongs which force the clamping members away from each other, thus releasing the barb like projection and forcing the bracket open.

In some embodiments, such as where the bracket is to be used with bottles having very narrow necks, it may be appropriate for openings 18, 20 to be omitted so long as the front and rear flanges secure the bottles when they are locked together. Except for the bridge 36, spacing between flanges 14 and 15 may extend all the way from the distal edges of the flanges to the proximal ends connected to the back plate, or may as illustrated in FIG. 1 extend only part of the distance from the distal edges to the junction with the back plate. For example, spacings 50, 51 seen in FIG. 7 extend roughly 80% of the distance from the junction 52 with the back plate to the distal edge 53 of flange 14.

Base flanges 14, 15 will each be connected, preferably integrally, to back plate 12 and will be at least partly spaced from each other, as illustrated in FIG. 1.

Bracket 110 (FIGS. 1a to 8a) is similar to bracket 100 except that it has space for an additional bottle. As such, front and rear flanges include three openings, 118, 119 and 120. Likewise, it includes three pairs 160, 170 and 180 of flanges 114, 115. Other features, such as back panel 112 and locks 132, 133 are similar.

Bracket 210 (FIG. 9) is similar to bracket 100 except that it has space for only one bottle and in that it employs an alternative lock. Lock 232 can be used in conjunction with any of the brackets of the invention regardless of the number of spaces for bottles. Bracket 210 comprises back plate 212, which is suitable for mounting to a wall outwardly of the plate (along the reverse side of the plate than that shown in FIG. 9). The back plate is planar or flat. One or more base flanges 214, 215 extend generally perpendicularly to the back plate inwardly (in the direction shown in FIG. 9) at a lower end thereof. A rear flange 216, extends generally perpendicular to the back plate inwardly at an upper end thereof. The rear flange includes opening 218 suitable for receiving a portion of an upper end a bottle. Bracket 210 is shown with openings for one bottle but it may have two or three or more.

Lock 232 comprises a key 233, a locking pin 270 and locking receptacle 272. Key 233 includes a grasping surface such as handle 280, and a base 284, the handle and base being connected by stem 286. At least the bottom of base 284 includes magnet 290. The bottom of base 284 is preferably relatively flat so that it can rest above an opening 239 in rear flange 216 leading to an opening in the locking receptacle which may be in the form of shaft 296 (FIG. 10) when it is desired to keep pin 270 in the open position, as will be explained hereinafter.

Pin 270 includes two generally cylindrical sections 271 and 273, the former having a larger diameter. Pin 270 has a ferromagnetic material at its upper end 297. Receptacle 272 is in the form of a block and includes cylindrical opening 274 leading to shaft 296 having a circumference sufficient to accommodate cylindrical section 271 when the pin is inserted into the opening. Receptacle 272 also includes a transverse opening or slot 275 which is generally perpendicular to shaft 296 and which is large enough to accommodate the thickness (the vertical dimension) of front locking flange 227. Receptacle 272 may be secured to rear plate 212 with a screw passing through opening 299 in rear plate 212 the screw then entering a screw hole in receptacle 272 or secured to the receptacle by other means. Alternatively, receptacle 272 can be secured to one of the front flanges or the flange connecting them and a flange extending from the rear plate can be received in the transverse opening of the receptacle.

As mentioned above rear flange 216 includes opening 239. Front locking flange 227 includes opening 229 having a diameter large enough to accommodate the smaller diameter pin section 273.

As can be seen in FIG. 10, in the locked position, pin 270 is situated at a lower end of cylindrical opening or shaft 296. When dropped into shaft 296, the pin moves to the lower end of the shaft as a result of gravity. The pin may be made of metal which is attracted to the ferromagnetic material of the key 233 when the key is used to unlock the bracket. The smaller diameter section 273 of pin 270 is received within opening 229 of front locking flange 227. This locks flange 227 and prevents flanges 227 and 226 from opening. When it is desired to unlock the bracket, magnet 290 is placed at or within opening 239 of rear flange 216, which forces pin 270 upwardly due to the magnetic field generate by one or both of the ferromagnetic materials on the bottom of key 233 and the top of pin 270 at 297, whereby pin 270 is raised to an upper end of shaft 296 with its ferromagnetic material proximal to the ferromagnetic surface of bottom 290 of the key whereby small diameter pin section 273 is removed from opening 229 and the front flange is then free to move away from the rear flange, thus unlocking the bracket. The upper end of pin 270 and the lower end of key 233 may be made of any suitable ferromagnetic material such as iron, steel, nickel or cobalt. Slot 275 accommodates movement of the lower front flange 227 before and after the pin has been removed.

It will be appreciated that while the key is illustrated as having ferromagnetic material on its bottom surface and the pin as having ferromagnetic material on its top surface, what is important is that the ferromagnetic materials be sufficiently close when the key is placed above shaft 296 to attract the pin sufficiently to move it from the lower end of the shaft where it fits within opening 229 and blocks movement of the front of the bracket to a position outside of opening 229, thereby permitting the bracket to open. Thus, for instance, there may be situations where the ferromagnetic material may be in an upper aspect of the pin, but not the uppermost surface, and/or in a lower aspect of the key but not the lowermost surface. Moreover, if desired the entire pin may be made of a metal attracted to ferromagnetic material in the key.

The brackets of the invention will typically be fabricated from stainless steel except that the lock may be made of thermoplastic, such as polypropylene or polyethylene, if desired, except for the magnet in the key and the locking pin in the embodiment employing a magnetized lock.

It should be understood, of course, that the specific forms of the invention herein illustrated and described are intended to be representative only as certain changes may be made therein without departing from the clear teachings of the disclosure. Accordingly, reference should be made to the following appended claims in determining the full scope of the invention.

What is claimed is:

1. A locking mechanism comprising:
a) A locking pin having a ferromagnetic upper surface or aspect,
b) A locking receptacle having a shaft suitable for receiving the pin,
c) The shaft intersecting with a transverse opening whereby a portion of the pin will be received within a portion of the transverse opening at least when the locking mechanism is in the closed position,
d) A key comprising a lower portion made of ferromagnetic material which is attracted to the locking pin ferromagnetic upper surface or aspect.

2. The locking mechanism of claim 1 wherein the ferromagnetic locking pin upper surface or aspect is comprised of one or more of iron, steel, nickel and cobalt.

3. The locking mechanism of claim 1 wherein the ferromagnetic material of the key is comprised of one or more of iron, steel, nickel and cobalt.

4. The locking mechanism according to claim 1 wherein the pin includes upper and lower generally cylindrical sections, the upper cylindrical section having a larger diameter than the lower section.

5. The locking mechanism according to claim 1 wherein the locking receptacle is in the form of a block.

6. The locking mechanism according to claim 1 wherein the transverse opening is a slot.

7. The locking mechanism according to claim 1 wherein key comprises a grasping surface.

8. A process of using the locking mechanism of claim 1 to lock a wall mounted bracket comprising a back plate and a front locking flange wherein the back plate and the front locking flange have an open position with the front locking flange distal from the back plate and a closed position with the front locking flange proximal to the back plate and wherein the locking receptacle is secured to one of the front flange and the back plate or flange, comprising with the front flange and rear plate in the closed position, dropping the locking pin within the shaft so that it extends through one of a front locking flange or a rear locking flange whereby a front locking flange and back plate are locked.

9. A process of opening the locking mechanism of claim 1 in a locked wall mounted bracket comprising a back plate and a front locking flange wherein the back plate and the front locking flange have an open position with the front locking flange distal from the back plate and a closed position with the front locking flange proximal to the back plate and wherein a locking receptacle is secured to one of the front flange and the back plate or a flange attached thereto, with the front flange and back plate in the closed position wherein the locking pin is dropped in a shaft in the locking receptacle so that it extends through one of a front locking flange or a rear locking flange whereby a front locking flange and back plate are locked, comprising apply the key to the upper end of the shaft in the locking receptacle to attract the locking pin to a position in an upper end of the shaft whereby at least part of the transverse opening is free of the pin and the front locking flange and the back plate are free to move with respect to each other.

10. A wall mountable bracket comprising the locking mechanism of claim 1 including:
a) a back plate suitable for mounting to a wall outwardly of the plate,
b) at least one front closing flange movable from a position proximal to the back plate to a position distal to the back plate,
c) the back plate optionally also including a flange’ such optional back plate flange extending inwardly from the back plate,
d) the locking receptacle being attached directly or indirectly to one of the back plate or the front closing flange,
e) the back plate flange or the closing flange being received within the transverse opening when the locking flange is proximal to the back plate whereby upon dropping the pin can lock the bracket.

11. The bracket according to claim 10 wherein one of the front locking flange or the back plate flange includes a pin-receiving opening into which the pin drops to lock the bracket.

12. The bracket according to claim 10 further comprising
a) One or more base flanges extending generally perpendicular to the back plate inwardly at a lower end thereof,
b) The back plate flange extending generally perpendicular to the back plate inwardly at an upper end thereof, and
c) the back plate flange and the one or more front locking flanges being pivotally connected at one of their ends,
d) the back plate flange and the front locking flange being suitable for securing between them a portion of an
upper end of a bottle.

13. The wall mountable bracket of claim 12 wherein said one or more base flanges comprise at least one pair of flanges connected by a bridge.

14. The wall mountable bracket of claim 13 wherein at least one said bridge comprises a protuberance extending above the bridge.

15. The wall mountable bracket according to claim 14 wherein the protuberance comprises a dome button.
